(19) United States
(12) Patent Application Publication
(10) Pub. No.: US 2025/0068865 A1
(43) Pub. Date: Feb. 27, 2025

(54) SYSTEMS AND METHODS FOR RFID TAG ORIENTATION PREDICTION

(71) Applicant: Georgia Tech Research Corporation, Atlanta, GA (US)

(72) Inventors: Ajibayo Adeyeye, Atlanta, GA (US); Jimmy Georges Donald Hester, Atlanta, GA (US); Charles A. Lynch, Atlanta, GA (US); Emmanouil Tentzeris, Atlanta, GA (US)

(21) Appl. No.: 18/814,834

(22) Filed: Aug. 26, 2024

Related U.S. Application Data
(60) Provisional application No. 63/578,971, filed on Aug. 25, 2023.

(51) Int. Cl. G06K 7/10; G06K 19/07

(52) U.S. Cl. CPC G06K 7/10356; G06K 19/0723

(57) ABSTRACT

Embodiments of the present disclosure include improvements to millimeter wave backscatter RFID technology for rotational sensing. Embodiments of the present disclosure leverage the polarization mismatch of linearly polarized antennas to capture rotational motion with high accuracy. One embodiment described herein includes utilization of a four-antenna system, each featuring a different modulation frequency. This configuration allows for independent extraction of rotational information by observing the changes in signal amplitudes as the angle of rotation varies. With a polarization offset of 15° between successive antennas, the backscatter channels trace distinct curves, enabling the resolution of angular ambiguities.

### CROSS-REFERENCE TO RELATED APPLICATIONS

This application claims priority to, and benefit of, U.S. Provisional Application Ser. No. 63/578,971, filed Aug. 25, 2023, and entitled “6-AXIS RFID TAG FOR ORIENTATION DETECTION.” The disclosure of which is hereby incorporated by reference in its entirety.

### BACKGROUND

Radio Frequency Identification (RFID) systems can include tags that are configured to emit signals in response to an interrogating signal from the reader. One or more readers can be configured to track, identify, or locate any number of tags by interrogating those tags. For example, tags can be placed on items in a warehouse, and readers throughout the warehouse can track the items as they move through the warehouse. RFID systems can also be used in other contexts, like virtual reality or augmented reality, where tracking the location of a user can be a key part of the virtual reality or augmented reality system. Improvements to the information that can be obtained from RFID tags can benefit existing uses of RFID tags, as well as enable RFID tags to be used in new applications.

### SUMMARY

Embodiments of the present disclosure include improvements to millimeter wave backscatter RFID technology for rotational sensing. Embodiments of the present disclosure leverage the polarization mismatch of linearly polarized antennas to capture rotational motion with high accuracy. An example embodiment described herein includes utilization of a four-antenna system, each featuring a different modulation frequency. This configuration allows for independent extraction of rotational information by observing the changes in signal amplitudes as the angle of rotation varies. By employing antennas with specific polarization offsets, the example embodiment overcomes the limitations of previous methods that relied on monitoring the phase of antenna pairs. With a polarization offset of 15° between successive antennas, the backscatter channels trace distinct curves, enabling the resolution of angular ambiguities. The simplicity and efficiency of the example tag design are also benefits. The use of cross-polarized patch antennas improves self-interference rejection on the reader side. Additionally, the RFID tag can operate as a four-in-one module, minimizing form factor and power consumption. The integration of low-cost, low-power components such as the cross-polarized patch antennas and low-noise FET contributes to the affordability and practicality of the design. The combination of millimeter wave frequencies and Frequency Modulated Continuous Wave (FMCW) radar-based detection further distinguishes this tag design. FMCW radar offers a cost-effective and high-performance interrogation system that has seen widespread deployment in various real-world applications. The example tags described herein can capitalize on the advantages of FMCW radar, achieving high localization accuracy while also providing crucial information about the orientation of the tagged object.

The described technology of millimeter wave backscatter RFID for rotational sensing holds significant potential for various commercial applications. It should be understood that the below examples are non-limiting examples, and that the RFID tags described herein can be used for any kind of rotational sensing in any context.

Augmented Reality (AR) and Virtual Reality (VR): The precise rotational sensing capability provided by this technology can enhance AR/VR experiences by accurately tracking users' head movements and gestures. This can improve immersion, interaction, and realism in virtual environments.

Gesture Recognition: The ability to capture and analyze precise rotational motion opens doors for gesture recognition applications. This technology can be utilized in areas such as gaming, human-computer interaction, and control interfaces, allowing users to interact intuitively with devices or virtual objects.

Motion Capture: The accurate tracking of rotational motion is valuable in motion capture systems used in the entertainment industry, sports analysis, and biomechanics research. This technology can enable the capture of detailed movements for animation, sports performance analysis, and rehabilitation applications.

Robotics and Industrial Automation: The rotational sensing capability can be applied to robotics and automation systems, enabling robots to precisely mimic human-like movements or handle objects with increased accuracy and dexterity. This can improve automation processes in industries such as manufacturing, logistics, and healthcare.

Smart Home and IoT: Integrating the example embodiment into smart home devices or Internet of Things (IoT) applications can enhance user interactions. For example, rotational sensing can be used in smart lighting systems to adjust brightness or color temperature based on users' movements or gestures.

Wearable Devices: Incorporating the millimeter wave backscatter RFID tag into wearable devices opens possibilities for accurate motion tracking and gesture control in fitness trackers, smartwatches, and healthcare monitoring devices.

Security and Access Control: The precise rotational sensing can be applied to security systems for authentication or access control purposes. For instance, it can enable gesture-based authentication or enhance the accuracy of biometric systems.

High Accuracy: The example embodiment achieves high accuracy in capturing rotational motion, with accuracy levels below 1 degree over a range of plus or minus 90 degrees. This level of precision surpasses many existing rotational sensing techniques, allowing for more accurate and reliable tracking of rotational movements.

Low-Cost Implementation: The design focuses on low-cost implementation, making it more accessible for commercial adoption. By utilizing low-cost components and leveraging existing millimeter wave backscatter RFID technology, the proposed solution offers a cost-effective alternative compared to complex and expensive rotational sensing systems.

Low-Power Consumption: The example tag design incorporates low-power components, resulting in reduced power consumption. This is advantageous for applications that require prolonged usage or operate on battery-powered devices, ensuring efficient energy usage and longer battery life.

Compact Form Factor: The example tag design features a compact form factor, making it suitable for integration into various devices and systems without imposing significant space constraints. This compactness enhances the versatility and ease of deployment of the technology in different applications.

Compatibility with Millimeter Wave Frequencies: Operating in the millimeter wave frequency range brings several benefits, including improved localization accuracy and reduced interference from other wireless signals. The integration of millimeter wave frequencies enhances the performance and reliability of the rotational sensing system.

Integration with FMCW Radar: The combination of millimeter wave backscatter RFID technology with frequency modulated continuous wave (FMCW) radar-based detection offers an added advantage. FMCW radar provides a cost-effective and high-performance interrogation system, enabling enhanced localization and tracking capabilities.

Range Limitations: The current implementation may have limitations in terms of the effective range for accurate rotational sensing. Extending the range while maintaining high accuracy across a wider angular span would be important for practical applications in larger spaces or scenarios where objects are located at a greater distance.

Environmental Interference: External factors such as environmental conditions, multipath reflections, and interference from other wireless signals can impact the performance of the rotational sensing system. Ensuring robustness and reliability in real-world environments with varying conditions can be used for practical applications.

Calibration and Alignment: Achieving accurate rotational sensing requires proper calibration and alignment of the system components, particularly the antennas. Streamlining the calibration process and developing techniques to handle misalignments or deviations can be used to ensure consistent and reliable performance.

Scalability and Deployment: The scalability and deployment of the technology can be considered. Embodiments of the present disclosure can manage interference and ensuring efficient operation in scenarios with a high density of tagged objects.

In some aspects, the techniques described herein relate to a system including: a tag including a plurality of antennas; a reader component configured to transmit signals to the tag; a processor; and a memory having computer-executable instructions stored thereon that when executed by the processor cause the processor to: transmit signals by the reader to the tag; receive a response from each antenna; and based on the responses received from each antenna, determine an orientation of the tag.

In some aspects, the techniques described herein relate to a system, further including a model, and wherein the computer-executable instructions when executed by the processor further cause the processor to: based on the responses received from each antenna, determine the orientation of the tag using model.

In some aspects, the techniques described herein relate to a system, wherein the model includes a machine learning classifier.

In some aspects, the techniques described herein relate to a system, wherein the machine learning classifier is a k-nearest neighbor machine learning classifier.

In some aspects, the techniques described herein relate to a system, wherein the tag is a millimeter-wave RFID tag.

In some aspects, the techniques described herein relate to a system, wherein the plurality of antennas includes cross polarized antennas.

In some aspects, the techniques described herein relate to a system, wherein the plurality of antennas includes at least four antennas.

In some aspects, the techniques described herein relate to a system, wherein the plurality of antennas includes at least three antennas.

In some aspects, the techniques described herein relate to a system, wherein each antenna of the plurality of antennas transmits using a different channel.

In some aspects, the techniques described herein relate to a system, wherein each channel is associated with a different modulation frequency.

In some aspects, the techniques described herein relate to a system, wherein each antenna of the of the plurality of antennas has a polarization offset of 15° from a previous antenna of the plurality of antennas.

In some aspects, the techniques described herein relate to a system, wherein determining the orientation of the tag includes determining one or more of roll, pitch, and yaw.

In some aspects, the techniques described herein relate to a method including: transmitting, by a processor, signals to a tag including a plurality of antennas; receiving, by the processor, a response to the signals from each antenna of the plurality of antennas; based on the responses received from each antenna, determining, by the processor, an orientation of the tag.

In some aspects, the techniques described herein relate to a method, further including a model, and based on the responses received from each antenna, determining the orientation of the tag using the model.

In some aspects, the techniques described herein relate to a method, wherein the model includes a machine learning classifier.

In some aspects, the techniques described herein relate to a method, wherein the machine learning classifier is a k-nearest neighbor machine learning classifier.

In some aspects, the techniques described herein relate to a method, wherein the tag is a millimeter-wave RFID tag.

In some aspects, the techniques described herein relate to a method, wherein the plurality of antennas includes cross polarized antennas.

In some aspects, the techniques described herein relate to a method, wherein the plurality of antennas includes at least four antennas.

In some aspects, the techniques described herein relate to a method, wherein determining the orientation of the tag includes determining one or more of roll, pitch, and yaw.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary RFID tag and orientation determiner;

FIG. 2 is an illustration of an exemplary RFID tag;

FIG. 3 is an operational flow of an implementation of a method for generating a model to predict the orientation of an RFID tag;

FIG. 4 is an operational flow of an implementation of a method for predicting the orientation of an RFID tag; and

FIG. 5 shows an exemplary computing environment in which example embodiments and aspects may be implemented.

### DETAILED DESCRIPTION

The details of one or more embodiments of the invention are set forth in the accompanying drawings and the description below. Other features, objects, and advantages of the invention will be apparent from the description and drawings and from the claims.

Throughout the description and claims of this specification, the word “comprise” and other forms of the word, such as “comprising” and “comprises,” means including but not limited to, and is not intended to exclude, for example, other additives, components, integers, or steps.

To facilitate an understanding of the principles and features of various embodiments of the present invention, they are explained hereinafter with reference to their implementation in illustrative embodiments.

In the coming years, augmented reality (AR) and virtual reality (VR) based applications will become common place. The proliferation of radar technology and the strong performance of millimeter wave backscatter can benefit from a low-cost and low-power solutions to support the advent of AR/VR. Embodiments of the present disclosure include millimeter wave backscatter RFID for rotational sensing. Embodiments of the RFID tag design described herein take advantage of the polarization mismatch of linearly polarized antennas as the angle between the pair is varied. A supervised learning algorithm is used to achieve extremely high accuracy<1° over an unambiguous range of ±90° thus allowing use in a wide variety of real-time applications.

### Example System and Methods:

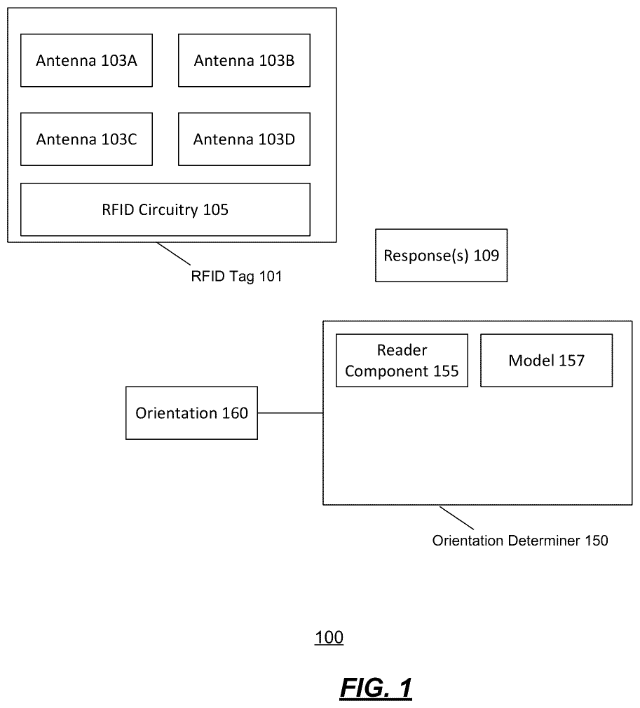

FIG. 1 is an illustration of an example system 100 for determining the orientation of an RFID tag 101. As shown, the system 100 includes an RFID tag 101 and an orientation determiner 150 that is adapted to predict the orientation of the RFID tag 101. In some embodiments, the system 100 may be well suited for augmented reality (AR) and virtual reality (VR) applications. These applications can require projecting information from human activity as well as physical objects into the digital world. A particular piece of enabling technology for these applications lies in the simultaneous localization and tracking of human movements and various objects.

For example, the system 100 can be integrated into an AR or VR application by incorporating the RFID tag 101 into the headset or other controller (“tagged object”) held or worn by a user. The AR or VR application may then use the orientation determiner 150 to determine the orientation of the RFID tag 101. Because the RFID tag 101 is incorporated into the tagged object, the determined orientation can be used to directly determine the orientation of the tagged object.

The three pieces of information required to describe the orientation of a tagged object can be defined by the axis through which the RFID tag rotates 101. They are the roll, pitch, and yaw corresponding to rotations about the x, y and z axes respectively. To provide the information needed to describe the orientation, the RFID tag 101 may include a plurality of antennas 103 (i.e., the antennas 103A, 103B, 103C, and 103D). In the example shown, four antennas 103 are used. However, more or fewer antennas 103 may be used. In some embodiments, the antennas are cross-polarized with respect to each other.

The RFID tag 101 further includes RFID circuitry 105. The RFID circuitry 105 is responsible for energy supply and the generation of the signals that are transmitted by the antennas 103.

Each antenna 103 may communicate with a reader component 155 of the orientation determiner 150. The reader component 155 may be an RFID reader (interrogator) and may interrogate the RFID tag 101 by sending a signal to the RFID tag 101. In response to the received signal, the RFID circuitry 105 causes each of the antennas 103 to transmit a signal back to the reader component 155. In some embodiment, the reader component 155 may be a FMCW radar-based reader component 155.

As will be described further below, each of the four antennas 103 represents a unique backscatter link with a different modulation frequency so that desired information can be extracted independently by the reader component 155 from each antenna 103. Effectively, the proposed RFID tag 101 operates as a four-in-one module. While only 3 total antennas 103 are needed to capture the required motion, a fourth antenna 103 provides benefits in reliability of the overall system 100.

Overall, the system 100 determines the orientation of the RFID tag 101 using a method that considers the amplitudes of the signals received from the antennas 103. This method relies on polarization mismatch. For a pair of linearly polarized antennas 103, the polarization loss factor (PLF) is given by the expression: PLF=cos²(ϕ) where ϕ is the angle of rotation between the antennas such that the electric fields are orthogonal when phi=90°.

However, since the antennas 103 are cross polarized to improve reader sensitivity they are symmetric about the main diagonal of the tag 101 thus giving a 45° angular ambiguity. This knowledge informs the core design step taken on the proposed RFID tag 101. In particular, in some embodiments, each of the antennas 103 on the proposed RFID tag 101 are arranged so that there is a polarization offset of 15° between each successive antenna 103 clockwise around the structure. This was done so that as the tag 101 is rotated about the z axis, each of the backscatter channels would trace out a different curve as the amplitude of the received signal changes and angular ambiguities of the tag 101 can thus be resolved based on the differing responses. The specific offset of 15° was chosen because a total of four antennas 103 are in use and each antenna 103 has an individual ambiguity of 45°. Where more or fewer antennas 103 are used, a different offset may be selected.

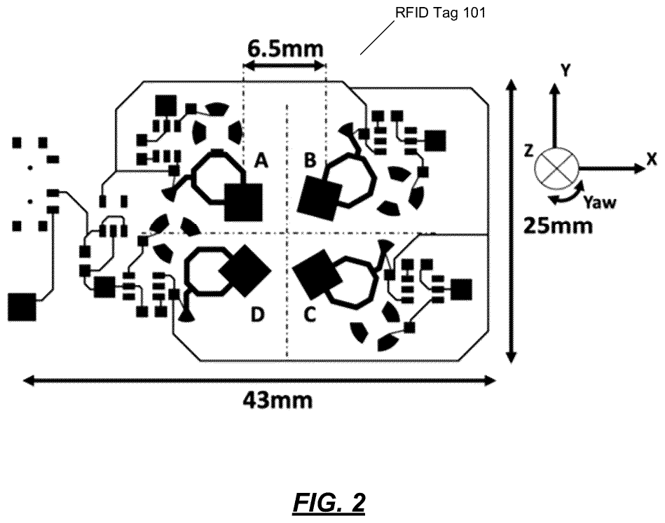

For example, with reference to FIG. 2, a schematic of the proposed RFID tag 101 is shown. The antennas 103A, 103B, 103C, and 103D are labeled on FIG. 2 as the antennas A, B, C, and D, respectively. Taking the upper left antenna A as the 0 reference, the antennas B, C and D are set with polarization offsets of 15°, 30° and 45° respectively. Each antenna further broadcasts using a different specific modulation frequency set to be in increasing order from A-D as 49 kHz, 69 kHz, 85 kHz, and 110 kHz. Other modulation frequencies may be used. Using different modulation frequencies allows the response from each antenna 103 to be collected independently and free of interference by the reader component 155.

Returning to FIG. 1, in order to determine the orientation of the RFID tag 101, the orientation determiner 150 may use a model 157. The model 157 may be adapted to take the amplitudes of each signal received from the antennas 103 and output a predicted orientation 160 of the RFID tag 101. In some embodiments, the orientation 160 may include only the predicted yaw of the RFID tag 101 because some or both of the roll or pitch of the RFID tag 101 can be determined using different means. Alternatively, the model 157 may predict all of the roll, pitch, and yaw.

The model 157 may be a machine learning model trained by the orientation determiner 150 using training data. Examples of a suitable model 160 include machine learning classifiers such as a k-Nearest Neighbor classifier. Other models may be used.

In some embodiments, the orientation determiner 150 may generate the training data for the model 157 by repeatedly interrogating the RFID tag 101 at a variety of different orientations 160. At each iteration, the orientation 160 of the RFID tag 101 may be recorded as well as the amplitudes of the signals that are received from each of the antennas 103. Thus, the training data may include a vector set of amplitudes collected from each antenna 103 at each orientation 160.

Where the model 157 is trained to only predict the yaw, at each iteration the yaw of the RFID tag 101 may be changed by one degree, and the amplitudes of the signals received from the antenna 103 may be recorded. The orientation determiner 150 may continue to change the yaw by one degree until all possible yaw values have been tested.

In embodiments where the model 157 is trained to predict the roll, pitch, or yaw, at each iteration the roll, pitch, or yaw of the RFID tag 101 may be changed by one degree, and the amplitudes of the signals received from the antenna 103 may be recorded. The orientation determiner 150 may continue to change the yaw, pitch, or roll each by one degree until all possible combinations of yaw, pitch, and roll have been tested.

Further, in either embodiment, when collecting the training data, a variety of ranges or distances between the reader component 155 and the RFID tag 101 may be considered. For example, the orientation determiner 150, for each change or orientation of the RFID tag 101, may collect signals from the antennas 103 at a variety of different ranges such as 0.5 m, 0.5625 m, 0.625 m, 0.6875 m and 0.75 m, for example. The ranges may be selected based on the maximum detection range of the RFID tag 101.

In some embodiments, after collecting the training data, the orientation determiner 150 may further standardize the amplitude of the signals recorded for each antenna 103. The standardization can be performed on the amplitude measurements independently by subtracting the mean of each vector set of measurements and dividing by the standard deviation of the data.

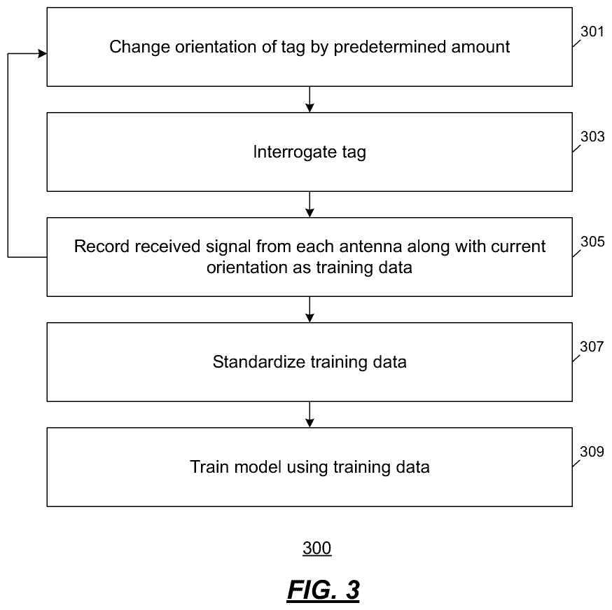

FIG. 3 is an illustration of an exemplary method 300 for training a model to predict an orientation of an RFID tag 101. The method 300 may be implemented by the orientation determiner 150.

At 301, an orientation of the tag 101 is changed. The orientation 160 of the tag 101 may be changed by a user or technician changing the orientation of the tag 101. The change in orientation may be a change to one or more of the roll, pitch, or yaw of the tag 101. Alternatively, the change may be only to the yaw of the tag 101. The amount of change may be 1 degree.

However, other amounts of change may be used. In addition to, or instead of, changing the orientation 160 of the tag 101, a distance between the tag 101 and the orientation determiner 150 may also be changed. Note that a variety of distances may be used to generate the training data.

At 303, after the orientation of the tag is changed, the tag may be interrogated. The tag 101 may be interrogated by the reader component 155 sending one or more signals to the antennas 103 of the RFID tag 101. Any method for interrogating an RFID tag 101 may be used. In some embodiments, the reader component 155 may use FMCW radar.

At 305, received signals from each of the antennas are recorded along with the current orientation as training data. The received signals may be recorded by the reader component 155. In some embodiments, the amplitude of each received signal may be recorded along with the orientation and an indication of the antenna 103 that generated the received signal. Each antenna 103 may be broadcast on a unique modulation frequency. Example frequencies include 49 kHz, 69 kHz, 85 kHz, and 110 kHz. Other frequencies may be used.

At 307, the recorded received signals of the training data are standardized. The signals may be standardized by the orientation determiner 150. The recorded signals may be standardized into a format used by the model 157. Any method may be used.

At 309, a model is trained using the training data. The model 157 may be trained by the orientation determiner 150 using some or all of the training data. The model 157 may be a machine learning classifier such as a k-nearest neighbor machine learning classifier. Other types of models may be used.

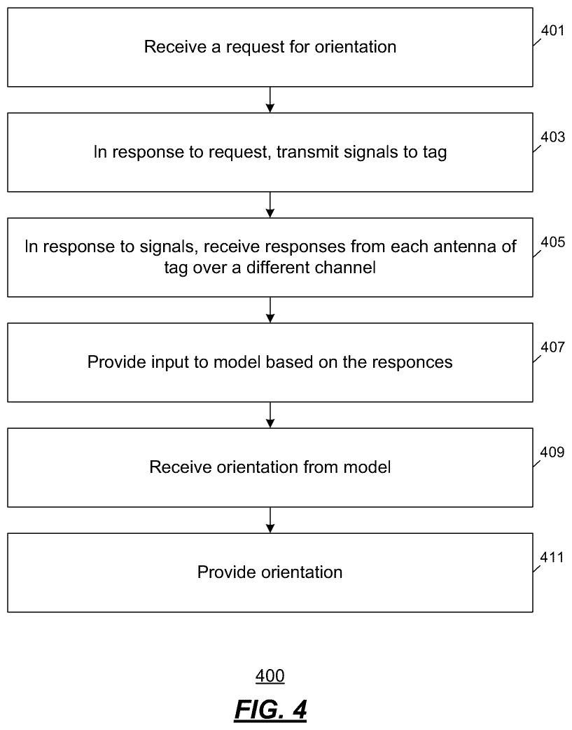

FIG. 4 is an illustration of an exemplary method 400 for predicting the orientation of a tag. The method 400 may be implemented by the orientation determiner 150.

At 401, a request for an orientation may be received. The request may be received by the orientation determiner 150 from an application such as a VR or AR application, for example. The request may be for the orientation of a tag 101. The tag 101 may be a millimeter wave RFID tag that is affixed or part of an object such as a controller or a headset. Thus, the orientation of the tag 101 can be used to determine the orientation of the object that the tag 101 is associated with. Depending on the embodiment, the orientation 160 may be some or all of the roll, the pitch, or the yaw of the tag 101, or just the yaw of the tag 101.

Depending on the embodiment, rather than receive the request for the orientation 160, the orientation determiner 150 may be configured to continuously update or generate the orientation 160. The frequency with which the orientation 160 is updated may be set by a user or administrator. Alternatively or additionally, the orientation determiner 150 may update the orientation 150 upon detecting that the RFID tag 101, or the other associated with the tag 101, has moved.

At 403, in response to the request, one or more signals are transmitted to the RFID tag 101. The one or more signals may be interrogation signals and may be transmitted by the reader component 155 of the orientation determiner 150. The reader component 155 may use FMCW radar.

At 405, in response to the signals, a response to the one or more signals is received from each antenna of the RFID tag 101. The responses may be received by the reader component 155 of the orientation determiner 150. As described above, the RFID tag 101 may include four antennas 103. Each antenna may have a different orientation on the RFID tag 101. For example, each antenna may have a different polarization offset with respect to the other antennas 103, such as 15°. Other offsets may be used. In addition, each antenna 103 may broadcast using a different modulation frequency. The use of the different modulation frequency may be used by the reader component 155 to determine which antenna 103 a particular response was received from. Alternatively or additionally, the reader component 155 may use identifying information included in each response to determine which antennas sent each response.

At 407, the input to a model is provided based on the responses. The input may be provided to the model 157 by the orientation determiner 150. The model 157 may be a machine learning classifier and may be similar to the model 157 trained by the method 300. Example models 157 may include a k-nearest neighbor model. Other types of models may be used.

In some embodiments, the input to the model may be based on the amplitude of each response received from each of the antennas 103. As may be appreciated, as the orientation of the tag 101 changes, the amplitude of the response received from each of the antennas 103 may change in different ways. The model 157 may have been trained to predict the orientation of the tag 101 based on the amplitudes of the response signals received from each antenna 103.

At 409, an orientation is received from the model. The orientation 160 may be received by the orientation determiner 150 from the model 157. The orientation determiner 150 may then provide the orientation 160 to the application associated with the orientation request (if any). Alternatively or additionally, the orientation determiner 150 may store the orientation 160 at a location that is accessible one or more applications that may use the orientation 160.

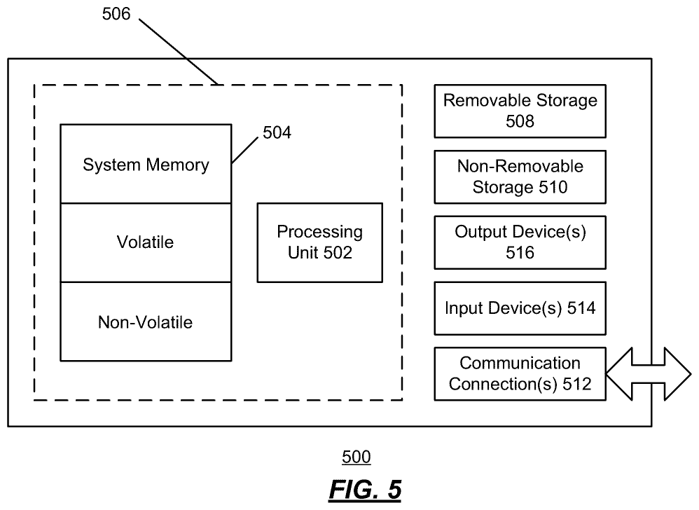

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a tag comprising a plurality of antennas;
a reader component configured to transmit signals to the tag;
a processor; and
a memory having computer-executable instructions stored thereon that when executed by the processor cause the processor to:
transmit signals by the reader component to the tag;
receive a response from each antenna; and
based on the responses received from each antenna, determine an orientation of the tag.

2. The system of claim 1, further comprising a model, and wherein the computer-executable instructions when executed by the processor further cause the processor to:
based on the responses received from each antenna, determine the orientation of the tag using the model.

3. The system of claim 2, wherein the model comprises a machine learning classifier.

4. The system of claim 3, wherein the machine learning classifier is a k-nearest neighbor machine learning classifier.

5. The system of claim 1, wherein the tag is a millimeter-wave RFID tag.

6. The system of claim 1, wherein the plurality of antennas comprises cross polarized antennas.

7. The system of claim 1, wherein the plurality of antennas comprises at least four antennas.

8. The system of claim 1, wherein the plurality of antennas comprises at least three antennas.

9. The system of claim 1, wherein each antenna of the plurality of antennas transmits using a different channel.

10. The system of claim 1, wherein each channel is associated with a different modulation frequency.

11. The system of claim 1, wherein each antenna of the plurality of antennas has a polarization offset of 15° from a previous antenna of the plurality of antennas.

12. The system of claim 1, wherein determining the orientation of the tag comprises determining one or more of roll, pitch, and yaw.

13. A method comprising:
transmitting, by a processor, signals to a tag comprising a plurality of antennas;
receiving, by the processor, a response to the signals from each antenna of the plurality of antennas; and
based on the responses received from each antenna, determining, by the processor, an orientation of the tag.

14. The method of claim 13, further comprising a model, and based on the responses received from each antenna, determining the orientation of the tag using the model.

15. The method of claim 14, wherein the model comprises a machine learning classifier.

16. The method of claim 15, wherein the machine learning classifier is a k-nearest neighbor machine learning classifier.

17. The method of claim 13, wherein the tag is a millimeter-wave RFID tag.

18. The method of claim 13, wherein the plurality of antennas comprises cross polarized antennas.

19. The method of claim 13, wherein the plurality of antennas comprises at least four antennas.

20. The method of claim 13, wherein determining the orientation of the tag comprises determining one or more of roll, pitch, and yaw.
